(19) United States
(12) Patent Application Publication
(10) Pub. No.: US 2026/0084234 A1
(43) Pub. Date: Mar. 26, 2026

(54) EVENT-BASED CAMERA, LASER BEAM MACHINING SYSTEM, AND USE OF THE EVENT-BASED CAMERA

(71) Applicant: Robert Bosch GmbH, Stuttgart (DE)

(72) Inventors: Meiko Boley, Leonberg (DE); Philip Neumann, Wennigsen (DE)

(21) Appl. No.: 19/113,508

(22) PCT Filed: Aug. 9, 2023
(86) PCT No.: PCT/EP2023/072057

§ 371 Date: Mar. 20, 2025

(30) Foreign Application Priority Data
Oct. 6, 2022 (DE) 10 2022 210 543.5

(51) Int. Cl. B23K 26/03; B23K 31/12; H04N 23/56

(52) U.S. Cl. CPC B23K 26/032; B23K 31/125; H04N 23/56

(57) ABSTRACT

An event-based camera for generating sensor data, in particular for a laser beam machining system. The event-based camera includes a camera chip and an objective for imaging an object in a detection range of the event-based camera onto the camera chip. The event-based camera includes an illumination device. The illumination device is configured to illuminate the camera chip with light. A laser beam machining system including the event-based camera for monitoring a laser beam machining process and the use of the event-based camera for monitoring a laser beam machining process, in particular for monitoring a laser beam welding process, are also described.

### FIELD

The present invention relates to an event-based camera, to a laser beam machining system, and to a use of the event-based camera.

### BACKGROUND INFORMATION

An apparatus for monitoring a laser machining process is described in Germany Patent Application No. DE 10 2019 209 376 A1. The apparatus is configured to detect splashes produced during the laser machining process, by evaluating sensor data, wherein, during the laser machining process, an event-based camera generates the sensor data to be evaluated.

### SUMMARY

An event-based camera according to the present invention for generating sensor data, in particular for a laser beam machining system is provided. According to an example embodiment of the present invention, the event-based camera comprises a camera chip and an objective for imaging an object in a detection range of the event-based camera onto the camera chip, wherein the event-based camera comprises an illumination device, and wherein the illumination device is configured to illuminate the camera chip with light, has the advantage that the recognizability of events, in particular the recognizability of splashes and ejections in a laser beam machining process, is improved since the sensitivity range of the event-based camera is shifted through the illumination of the camera chip.

The present invention is based on the surprising finding below. An event-based camera registers contrast changes, which are specified according to the Weber contrast:

$${K}_{Weber} = \frac{{I}_{U} - {I}_{L}}{{I}_{L}}$$

Here, IL is the basic brightness before and IU is the brightness after the change. If a preset contrast value K_{Weber} is exceeded, the event-based camera triggers an event. If the basic brightness of the object to be observed is low, IL goes to →0 and thus K_{Weber} goes to → ∞. It follows therefrom that the event-based camera triggers an event at low basic brightness even in the case of small brightness changes. The event-based camera is thus very sensitive so that even objects that are not to be observed, for example the machined workpiece itself when observing splashes in laser beam welding, are output as sensor data. The present invention described below solves this problem by shifting the sensitivity range of the event-based camera by increasing the basic illumination IL through the illumination of the camera chip. The recognizability of splashes and/or ejections in laser beam welding is thus improved in a particularly advantageous manner.

An event-based camera, also known as a neuromorphic camera or dynamic vision sensor, is a camera that responds to local brightness changes. In an event-based camera, each pixel operates independently and asynchronously and generates sensor data when brightness changes occur. The operating principle of an event-based camera is similar to the functioning of the human retina. For example, the event-based camera is designed to send only local changes in cells and/or pixels of the event-based camera instead of unnecessarily transmitting full images at constant frame rate, wherein the changes are, for example, due to movement as in the case of splashes. The event-based camera is therefore also referred to as the dynamic vision sensor (DVS) or event-based sensor or event sensor or change sensor. In particular, the event-based camera is designed to send changes in the pixels and/or cells at the time they occur. This results in a temporal resolution in the microsecond range in a particularly preferred manner. The event-based camera comprises a cell matrix with cells. In particular, the cells of the cell matrix may be regarded as pixels. The event-based camera is designed to determine intensity changes in a cell of the cell matrix as intensity data. In particular, the event-based camera is designed to detect the intensity changes in a predetermined time interval t1 in which they occur. Preferably, the time interval t1 results from the time points of an intensity change detected by the event-based camera. Event-based cameras therefore constitute a change-sensitive form of a camera the operating principle of which has been adapted from the biology of the human eye. The event-based camera does not record images in equidistant time steps like traditional image sensors, such as CMOS image sensors, but measures temporal intensity differences at individual pixel positions and sends only them immediately with microsecond accuracy and millisecond latency. Thus, if the intensity of a pixel does not change or changes only slightly, no event is triggered and no data are sent for this pixel. In summary, the event-based camera has a high dynamic of >120 dB at a high temporal resolution of about 1 μs. Furthermore, the event-based camera has a low latency of <100 μs. Due to the low data rate, the requirements for the bandwidth, the memories, and the computer performance for the transmission, the memories, and the post-processing are low. In addition, the event-based camera is characterized by a compact design.

According to an example embodiment of the present invention, it is advantageous that the illumination device is configured to illuminate the camera chip homogeneously with the light since this ensures that the entire camera chip has the same sensitivity at each pixel so that the same event is registered at every pixel position in a comparable manner.

According to an example embodiment of the present invention, particularly advantageous is also the embodiment in which the illumination device is arranged within the objective. This has the advantage of a compact design of the event-based camera. Furthermore, the illumination device is protected from environmental influences, for example splashes from the laser machining process.

According to an example embodiment of the present invention, it is also advantageous that the illumination device is configured to emit the light into the objective in a diffuse manner and/or that the event-based camera comprises a diffuser. This contributes to a homogeneous illumination of the camera chip and thus to a uniform sensitivity of the event-based camera. It is advantageous that the diffuser is arranged in front of the illumination device for diffusing the light emitted by the light source, in particular that the diffuser is arranged in front of the illumination device designed as a point light source and/or as an annular light source.

An annular light source contributes to a small design of the event-based camera. Furthermore, the annular light source has the advantage that the homogeneity of the illumination is further improved.

Advantageous is also an example embodiment of the present invention in which the objective comprises a beam splitter and the beam splitter is arranged on an optical axis of the event-based camera, wherein the illumination device is arranged outside the objective in such a way that the illumination device illuminates the camera chip with the light via the beam splitter. This embodiment has the advantage that there are design freedoms in the configuration of the illumination device so that the illumination device can be optimized for the illumination of the camera chip. It is advantageous that a diffuser is arranged between the illumination device and the beam splitter in order to improve the homogeneity of the illumination of the camera chip.

Particularly advantageous is also an example embodiment of the present invention in which the illumination device outside the objective of the event-based camera is arranged in the detection range of the event-based camera in such a way that the light emitted by the illumination device illuminates the camera chip substantially exclusively since this embodiment requires no change in the objective or the other structure of the event-based camera. Rather, the illumination device can simply be attached to the objective. This is an advantageous retrofit solution. It is advantageous that the event-based camera comprises a shielding device, wherein the shielding device is arranged between the illumination device and the imaged object in such a way that the object is shielded from the light emitted by the illumination device.

According to an example embodiment of the present invention, it is also advantageous that the event-based camera comprises an optical filter, wherein the optical filter is arranged in a beam path of the event-based camera, in particular in the objective, and/or wherein a transmission wavelength of the optical filter is substantially equal to an emission wavelength of the light emitted by the illumination device. The optical filter further increases the sensitivity of the event-based camera since ambient light is filtered out, for example.

The present invention furthermore comprises a laser beam machining system comprising the described event-based camera for monitoring a laser beam machining process. Preferably, according to an example embodiment of the present invention, the laser beam machining system comprises an evaluation device, wherein the evaluation device is configured to use the sensor data generated by the event-based camera to detect splashes and/or ejections produced in the laser beam machining process.

Furthermore, an example embodiment of the present invention comprises the use of the described event-based camera for monitoring a laser beam machining process, in particular for monitoring a laser beam welding process. Furthermore, alternatively or additionally, the present invention comprises the use of the event-based camera with a line laser. Particularly advantageous is the use of the described camera when the image is very dark to a large extent, for example due to an optical filter, and bright objects are also observed.

The use of the event-based camera for observing splashes and ejections contributes to the quality assurance of laser beam machining processes and laser beam welding processes since it can minimize waste and prevent the production of bad parts.

The described advantages of the event-based camera otherwise apply accordingly, and particularly to the described laser beam machining system and to the use of the event-based camera in a laser beam machining process.

Further advantages arise from the following description of embodiment examples of the present invention with reference to the figures and from the rest of the disclosure herein.

### BRIEF DESCRIPTION OF THE DRAWINGS

Embodiment examples of the present invention are shown in the multiple figures and are explained in more detail in the following description.

FIG. 1 shows an event-based camera of a first embodiment example of the present invention.

FIG. 2 shows an event-based camera of a second embodiment example of the present invention.

FIG. 3 shows an event-based camera of a third embodiment example of the present invention.

FIG. 4 shows an event-based camera of a fourth embodiment example of the present invention.

FIG. 5 shows an event-based camera of a fifth embodiment example of the present invention.

FIG. 6 shows a laser beam machining system, according to an example embodiment of the present invention.

### DETAILED DESCRIPTION OF EXAMPLE EMBODIMENTS

An event-based camera according to the present invention for generating sensor data is described below. The event-based camera comprises a camera chip and an objective for imaging an object in a detection range of the event-based camera onto the camera chip, wherein the event-based camera comprises an illumination device, and wherein the illumination device is configured to illuminate the camera chip with light. Furthermore, a laser beam machining system comprising the event-based camera for monitoring a laser beam machining process and the use of the event-based camera for monitoring a laser beam machining process, in particular for monitoring a laser beam welding process, are described.

A structure of an illumination device for an event-based camera is described below. The illumination device illuminates the camera chip and not the object in the detection range of the event-based camera. Preferably, the illumination device is integrated in the objective. Four preferred embodiment examples of the illumination device for illuminating the camera chip as well as their arrangement and integration in the event-based camera are described below. Optionally, the event-based camera comprises an optical filter in front of the objective.

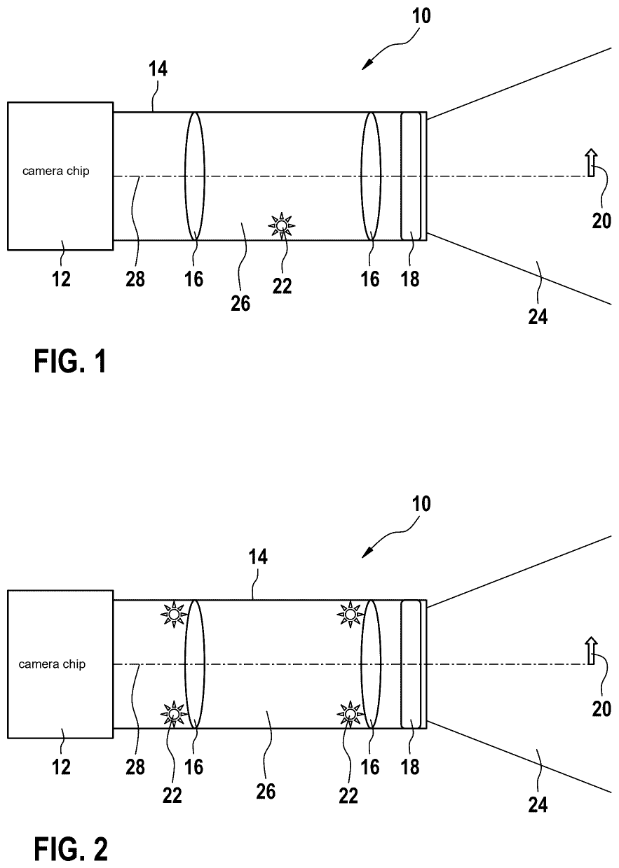

FIG. 1 shows the structure of an event-based camera 10 of a first embodiment example. The event-based camera 10 comprises a camera chip 12 and an objective 14 with one or more lenses 16. The event-based camera 10 is configured to capture an object 20 located in a detection range 24 of the event-based camera 10, by imaging the object 20 through the objective 14 onto the camera chip 12. The camera chip 12 of the event-based camera 10 comprises pixels, wherein the pixels are configured to generate sensor data independently and/or asynchronously from other pixels of the camera chip 12 if a brightness change detected by the pixel(s) is greater than a predetermined threshold value. The pixels are in particular arranged in a matrix. In the embodiment example, the event-based camera 10 comprises an optical filter 18, which is arranged on the optical axis 28 in the objective 14 after the last lens 16 of the objective 14. Furthermore, in the first embodiment example, the event-based camera 10 comprises an illumination device 22, which is arranged in the objective 14 and has a point light source, which emits light in a diffuse and undirected manner into the objective 14 in such a way that the camera chip 12 is illuminated, in particular substantially homogeneously, in particular with a uniform illuminance. In the first embodiment example, the illumination device 22 is arranged between two lenses 16 in the objective 14, preferably on an inner side of an objective wall of the objective 14.

FIG. 2 shows the structure of an event-based camera 10 of a second embodiment example. The event-based camera 10 comprises a camera chip 12 and an objective 14 with one or more lenses 16. The event-based camera 10 is configured to capture an object 20 located in a detection range 24 of the event-based camera 10, by imaging the object 20 through the objective 14 onto the camera chip 12. The camera chip 12 of the event-based camera 10 comprises pixels, wherein the pixels are configured to generate sensor data independently and/or asynchronously from other pixels of the camera chip 12 if a brightness change detected by the pixel(s) is greater than a predetermined threshold value. The pixels are in particular arranged in a matrix. In the embodiment example, the event-based camera 10 comprises an optical filter 18, which is arranged on the optical axis 28 in the objective 14 after the last lens 16 of the objective 14. Furthermore, in the second embodiment example, the event-based camera 10 comprises two illumination devices 22 arranged in the objective 14, which illumination devices are designed as annular light sources and emit the light in a directed manner onto the camera chip 12 in such a way that the camera chip 12 is illuminated, in particular that the camera chip 12 is illuminated substantially homogeneously, in particular with a uniform illuminance. In this second embodiment example, the first of the two annular light sources of the illumination device 22 is arranged between the camera chip 12 and a first lens 16 in the region of the first lens 16 with the beam direction toward the camera chip 12. A second annular light source of the illumination device 22 is arranged in front of a second lens 16 with the beam direction toward the camera chip 12. The annular light source is designed in such a way that individual point-shaped light sources are arranged equidistantly on a ring. In a variant of the second embodiment example, the event-based camera 10 comprises only one illumination device 22 with a single annular light source.

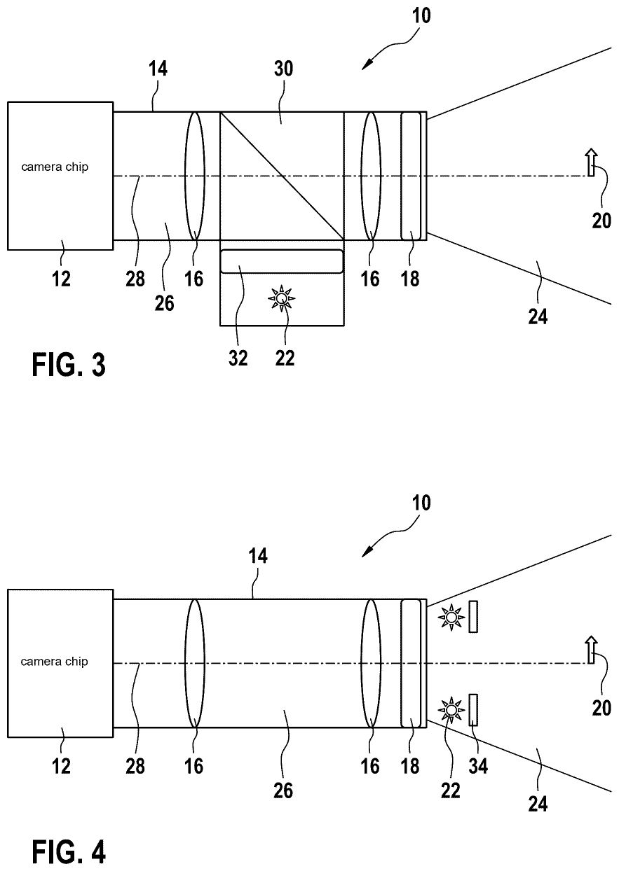

FIG. 3 shows the structure of an event-based camera 10 of a third embodiment example. The event-based camera 10 comprises a camera chip 12 and an objective 14 with one or more lenses 16. The event-based camera 10 is configured to capture an object 20 located in a detection range 24 of the event-based camera 10, by imaging the object 20 through the objective 14 onto the camera chip 12. The camera chip 12 of the event-based camera 10 comprises pixels, wherein the pixels are configured to generate sensor data independently and/or asynchronously from other pixels of the camera chip 12 if a brightness change detected by the pixel(s) is greater than a predetermined threshold value. The pixels are in particular arranged in a matrix. In the embodiment example, the event-based camera 10 comprises an optical filter 18, which is arranged on the optical axis 28 in the objective 14 after the last lens 16 of the objective 14. Furthermore, in the third embodiment example, the event-based camera 10 comprises a beam splitter 30. The beam splitter 30 is arranged on the optical axis 28 between two lenses 16. Furthermore, the event-based camera 10 of the third embodiment example comprises an illumination device 22 arranged outside the objective 14. The beam splitter 30 is configured, on the one hand, to direct light from the object 20 in the detection range 24 of the event-based camera 10 substantially unchanged to the camera chip 12 and, on the other hand, to deflect light from the illumination device 22 in such a way that the light of the illumination device 22 illuminates the camera chip 12. In the third embodiment example, the beam splitter 30 is designed as a percentage division beam splitter. In a variant, the beam splitter 30 is designed as a wavelength division beam splitter. Furthermore, a diffuser 32 is arranged between the illumination device 22 and the beam splitter 30. The diffuser 32 is preferably designed as a diffusion disk for diffusing the light emitted by the illumination device 22. The illumination device 22 with the diffuser 32 and the beam splitter 30 are configured to illuminate the camera chip 12 substantially homogeneously, in particular with a uniform illuminance.

FIG. 4 shows the structure of an event-based camera 10 of a fourth embodiment example. The event-based camera 10 comprises a camera chip 12 and an objective 14 with one or more lenses 16. The event-based camera 10 is configured to capture an object 20 located in a detection range 24 of the event-based camera 10, by imaging the object 20 through the objective 14 onto the camera chip 12. The camera chip 12 of the event-based camera 10 comprises pixels, wherein the pixels are configured to generate sensor data independently and/or asynchronously from other pixels of the camera chip 12 if a brightness change detected by the pixel(s) is greater than a predetermined threshold value. The pixels are in particular arranged in a matrix. In the embodiment example, the event-based camera 10 comprises an optical filter 18, which is arranged on the optical axis 28 in the objective 14 after the last lens 16 of the objective 14. Furthermore, in the fourth embodiment example, the event-based camera 10 comprises an illumination device 22 arranged outside the objective 14. The illumination device 22 is arranged in the detection range 24 of the event-based camera 10 in such a way that the light emitted by the illumination device 22 substantially exclusively illuminates the camera chip 12. For this purpose, the event-based camera 10 comprises a shielding device 34, wherein the shielding device 34 is arranged between the illumination device 22 and the imaged object 20 in such a way that the object 20 is shielded from the light emitted by the illumination device 22. Preferably, the illumination device 22 is designed as an annular light source. It is also preferred that the annular light source is designed in such a way that individual point-shaped light sources are arranged equidistantly on a ring. Furthermore, the shielding device 34 is designed as a ring in such a way that the light emitted by the annular light source substantially exclusively illuminates the camera chip 12 and substantially does not illuminate the object 20 in the detection range 24 of the event-based camera 10 so that the substantial proportion of the light is emitted toward the camera chip 12. The illumination device 22 with the annular light source and the shielding device 34 are configured to illuminate the camera chip 12 substantially homogeneously, in particular with a uniform illuminance.

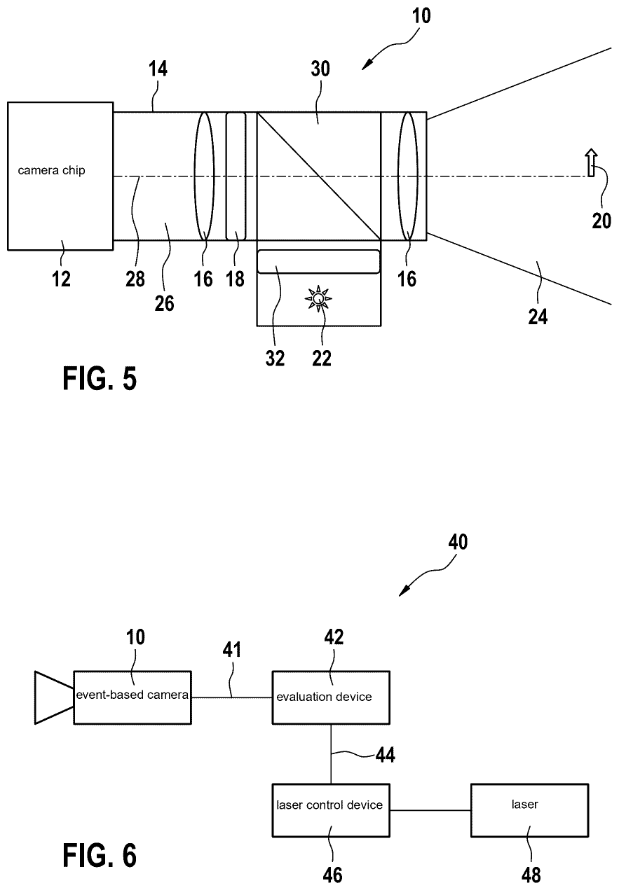

FIG. 5 shows the structure of an event-based camera 10 of a fifth embodiment example. The event-based camera 10 comprises a camera chip 12 and an objective 14 with at least two lenses 16. The event-based camera 10 is configured to capture an object 20 located in a detection range 24 of the event-based camera 10, by imaging the object 20 through the objective 14 onto the camera chip 12. The camera chip 12 of the event-based camera 10 comprises pixels, wherein the pixels are configured to generate sensor data independently and/or asynchronously from other pixels of the camera chip 12 if a brightness change detected by the pixel(s) is greater than a predetermined threshold value. The pixels are in particular arranged in a matrix. In this embodiment example, the event-based camera 10 comprises an optical filter 18, which is arranged on the optical axis 28 in the objective 14 between the at least two lenses 16 of the objective 14. Furthermore, in the fifth embodiment example, the event-based camera 10 comprises a beam splitter 30. The beam splitter 30 is arranged on the optical axis 28 between the at least two lenses 16. Furthermore, the event-based camera 10 of the fifth embodiment example comprises an illumination device 22 arranged outside the objective 14. The beam splitter 30 is configured, on the one hand, to direct light from the object 20 in the detection range 24 of the event-based camera 10 substantially unchanged to the camera chip 12 and, on the other hand, to deflect light from the illumination device 22 in such a way that the light of the illumination device 22 illuminates the camera chip 12. In the fifth embodiment example, the beam splitter 30 is designed as a percentage division beam splitter. In a variant, the beam splitter 30 is designed as a wavelength division beam splitter. Furthermore, a diffuser 32 is arranged between the illumination device 22 and the beam splitter 30. The diffuser 32 is preferably designed as a diffusion disk for diffusing the light emitted by the illumination device 22. The illumination device 22 with the diffuser 32 and the beam splitter 30 are configured to illuminate the camera chip 12 substantially homogeneously, in particular with a uniform illuminance. In a variant of the fifth embodiment example, the illumination device 22 directly illuminates the beam splitter 30 without a diffuser 32 being present. In particular, the objective 14 comprises a lens 16 in front of the camera chip 12 and a last lens 16 in front of the object 20, wherein the optical filter 18 is arranged between the lens 16 in front of the camera chip 12 and the beam splitter 30 and/or the beam splitter 30 is arranged between the optical filter 18 and the last lens 16. Preferably, the optical filter 18 has a transmission wavelength of 840 nm with a full width at half maximum of 40 nm so that the camera chip 12 has an observation wavelength of 840 nm. In particular, the illumination device 22 comprises an LED and/or the illumination devices 22 emits light with an emission wavelength of 840 nm.

In a variant, the illumination devices described with reference to FIGS. 1 to 5 are combined in an event-based camera so that, for example, the event-based camera comprises both an illumination device according to FIG. 3 and additionally an illumination device according to FIG. 4.

In a further variant, the optical filter is arranged on the optical axis on the camera chip and/or between the camera chip and the first lens and/or between the lenses. The illumination wavelength depends on the position of the optical filter, in particular on whether the optical filter is arranged on the optical axis in front of or behind the illumination device. If the illumination device is arranged in front of the optical filter, i.e., between the camera chip and the optical filter, any illumination wavelength may be selected. If the illumination device is arranged after the optical filter, i.e., between the optical filter and the object, a wavelength corresponding to the filter wavelength is selected as the illumination wavelength.

In the embodiment examples described above, the illuminance caused on the camera chip by the illumination device is selected in such a way that the illuminance is less than the luminance of the objects to be detected, in such a way that the objects to be detected are still visible and/or that the illuminance is such that interfering events, for example smoke and/or the vapor torch during welding and/or the environment and/or the noise of the event-based camera, are not detected as events.

FIG. 6 shows a laser beam machining system 40. The laser beam machining system 40 comprises an event-based camera 10 described with reference to FIGS. 1 to 4. The laser beam machining system 40 is configured, by means of the event-based camera 10, to monitor a laser beam machining process, in particular a laser beam welding process. The laser beam machining system 40 comprises an evaluation device 42, wherein the evaluation device 42 is configured to use the sensor data 41 generated by the event-based camera 10 to detect events occurring in the laser beam machining process and to identify these detected events 44 as splashes and/or ejections. Furthermore, the laser beam machining system 40 comprises a laser control device 46 and a laser 48 for machining a workpiece. The laser beam machining system 40 is configured to set parameters of the laser 48 via the laser control device 46 as a function of the detected events 44, in particular the identified splashes and/or ejections.

1-15. (canceled)

16. An event-based camera for generating sensor data, comprising:
a camera chip and an objective configured to image an object in a detection range of the event-based camera onto the camera chip; and
an illumination device configured to illuminate the camera chip with light.

17. The event-based camera according to claim 16, wherein the illumination device is configured to illuminate the camera chip homogeneously with the light.

18. The event-based camera according to claim 16, wherein the illumination device is arranged within the objective.

19. The event-based camera according to claim 16, wherein: (i) the illumination device is configured to emit the light in a diffuse manner into the objective, and/or (ii) the event-based camera includes a diffuser.

20. The event-based camera according to claim 16, wherein the illumination device is a point light source and/or as an annular light source.

21. The event-based camera according to claim 16, wherein the objective includes a beam splitter, and the beam splitter is arranged on an optical axis of the event-based camera, wherein the illumination device is arranged outside the objective in such a way that the illumination device illuminates the camera chip with the light via the beam splitter.

22. The event-based camera according to claim 21, wherein the diffuser is arranged between the illumination device and the beam splitter.

23. The event-based camera according to claim 16, wherein the illumination device is arranged outside the objective of the event-based camera in the detection range of the event-based camera in such a way that the light emitted by the illumination device substantially exclusively illuminates the camera chip.

24. The event-based camera according to claim 23, further comprising:
a shielding device arranged between the illumination device and the imaged object in such a way that the object is shielded from the light emitted by the illumination device.

25. The event-based camera according to claim 16, wherein: (i) the event-based camera includes an optical filter, wherein the optical filter is arranged in a beam path of the event-based camera, in the objective and/or (ii) a transmission wavelength of the optical filter is substantially equal to an emission wavelength of the light emitted by the illuminating device.

26. The event-based camera according to claim 16, wherein the camera chip includes a plurality of pixels, wherein each pixel generates the sensor data independently and/or asynchronously with other pixels when a brightness change is greater than a predetermined threshold value.

27. The event-based camera according to claim 26, wherein the pixels of the camera chip are arranged in a matrix.

28. A laser beam machining system, comprising:
an event-based camera configured to monitor a laser beam machining process, the event-based camera configured to generate sensor data for the laser beam machining system, the event-based camera:
a camera chip and an objective configured to image an object in a detection range of the event-based camera onto the camera chip; and
an illumination device configured to illuminate the camera chip with light.

29. The laser beam machining system according to claim 28, wherein the laser beam machining system includes an evaluation device, wherein the evaluation device is configured to use sensor data generated by the event-based camera to detect splashes and/or ejections produced in the laser beam machining process.

30. The event-based camera according to claim 16, wherein the event-based camera is configured to monitor a laser beam machining process including monitoring a laser beam welding process.
